(19) United States
(12) Patent Application Publication
(10) Pub. No.: US 2003/0195821 A1
(43) Pub. Date: Oct. 16, 2003

(54) QSR ordering system and method for drive thru operations

(76) Inventor: Jack J. Kennamer, Maineville, OH (US)

Correspondence Address: ALIX YALE & RISTAS LLP, 750 MAIN STREET, SUITE 1400, HARTFORD, CT, 06103, US

(21) Appl. No.: 10/411,569

(22) Filed: Apr. 10, 2003

Related U.S. Application Data
(60) Provisional application No. 60/372,135, filed on Apr. 12, 2002.

(51) Int. Cl. G06F 17/60

(52) U.S. Cl. 705/26; 705/64

(57) ABSTRACT

A system for a fast food drive-through restaurant having multiple remote ordering stations, each having a camera to take a photographic image of the patron and/or patron's vehicle which is then associated with the patron's order record in the restaurant. The invention overcomes the primary issue of order sequencing. The photo and order number could be presented in a variety of fashions including a touch screen with picture and order number of all the cars currently in the queue, so that when the order is complete, the presenter would tap that photo on the touch screen indicating the order has been filled and the photo would be removed from the system.

### BACKGROUND OF THE INVENTION

This invention relates generally to ordering systems for use in a business establishment having multiple locations for order placement and locations for order preparation and closing activities which are physically separated from the locations for order placement. More particularly, the present invention relates to a method and associated system for decreasing the time required to serve drive-through customers of a quick service restaurant (QSR).

Many business establishments and in particular fast food restaurants have for many years provided drive-through service to its patrons. In such a restaurant, the patron typically drives his/her automobile through a designated traffic lane or drive running along at least one portion of the main restaurant building. Typically, such drive-through systems include an ordering station with a menu board located remotely from the building along the designated drive-through lane. As the patron enters the drive-through along the designated path, the patron first encounters the ordering station located adjacent the traffic drive. There, the patron temporarily stops his or her vehicle adjacent to the order station in order to examine the menu board which displays the various food items offered by the restaurant. In many prior art systems, a two-way audio speaker device is located adjacent the menu board at the ordering station and is connected to a corresponding device in the restaurant which enables and employee or attendant of the restaurant, within the restaurant building, to communicate orally with the patron as the patron remains within his/her vehicle. Shortly after the patron has arrived at the ordering station, typically the restaurant employee within the restaurant building activates the two-way speaker in a manner so that the employee's voice is communicated through the ordering station and to the patron so that the employee may assist the patron in the selection of the various food products. Additionally, the two-way audio system allows the patron to communicate his or her food selection orally to the restaurant employee through the two-way speaker system.

At that time, the restaurant employee, located within the restaurant building, records the selection of food items made by the patron at the end of the selection process. The food items and associated prices are listed on an order record or receipt and the employee them communicates the selection to the other restaurant employees where the various food items are prepared and/or collected. The patron then proceeds along the designated traffic drive to the restaurant building. Typically the restaurant building includes one or more windows located immediately adjacent to the drive path. Commonly, the patron first encounters a payment window where the employee collects money from the patron based on the order record generated by a point-of-sale (POS) terminal in the restaurant. The patron then proceeds to a pick-up or presenter window and receives the items. At that time, the patron then proceeds along the drive-through path and exits the restaurant premises.

In a typical prior art drive-through operation described above, the customer communicates only verbally to the attendant in making his/her selections and the attendant communicates only verbally to the patron in assisting the patron in the selection process as well as confirming the particular order. Therefore, the QSR employee has no way of associating a particular order with the proper patron other than through voice recognition or inquiry to the patron.

The fast-food industry is estimated at about $129 billion annual sales. More than half the money spent at QSR's is attributed to the drive-through sales. In the U.S. about 80% of the fast food industry growth over the past five years has been at the drive-through.

QSR industry leaders recognize that the speed with which the patron is served at the drive-through is critical to generating sales and repeat customers. For example, McDonald's CEO Jack Greenberg has told industry analysts that unit sales increase 1% for every 6 seconds saved at the drive-through. And sales at a single McDonald's restaurant grow $15,000 a year for each second it shaves off drive-through time, a 1999 study says. USA Today, Apr. 3, 2002, Money Section, pp. 1-2.

QSR establishments have taken many steps to increase service and decrease customer service time. Measures include installing clearer speaker systems, utilizing wireless headsets for order-takers, adding digital screens that show customers what they ordered, accepting payment by a transponder used for payment, and the like.

The QSR's are continuously seeking ways to increase through-put in the drive-through portion of their business and decrease service time. They have identified the bottleneck as being the order entry point of their system. Because of ever increasing menus to offer greater appeal to the customers, patrons are spending more time at the order/menu board station, thus slowing down the process. Also, orders are becoming larger taking even more time to accommodate more that one individual per vehicle.

One possible solution to the above described problems is to introduce the use of mobile order entry terminals which allow a restaurant employee to physically go to the drive-through lane and enter orders, which increases through-put by providing two points of entry: the menu sign and the mobile order entry terminal. Problems associated with this option include: (1) interfacing the mobile entry terminal to the current POS system; (2) supporting multiple languages and interfaces; (3) constant menu changes and additions; (4) safety of the employee; (5) weather conditions; (6) hardware costs;, (7) order sequencing; and (8) the customer is unable to review the menu prior to ordering.

The addition of more ordering stations and menu boards has been another possible solution. The primary issue regarding this solution is order sequencing, i.e., the person at ordering station 2 is faster than the person at ordering station 1, thus their order number is ahead of the car in front of them, thus confusing the delivery system at the presenter and payment stations of the drive-through.

Therefore, a system is needed that enables a QSR or fast food establishment to process more customer orders in a given time period. The system should allow fast food vendors to increase the number of customers serviced without decreasing order accuracy or the quality of the food. Also, the system should allow the fast food vendors to utilize as much of their existing infrastructure as possible. Additionally, the system should provide customers with added convenience to give them incentive to use the system. finally, the system should take advantage of existing technologies, to the extent possible; so that the cost of implementing the system is minimized.

### SUMMARY OF THE INVENTION

These and other problems with known QSR drive-through systems have been solved by this invention. In one embodiment the invention includes attaching a digital camera to the drive-through menu system. When an order is placed, a photo is taken of the car and/or the driver from approximately the same angle and distance that the drive-through employee would view when the car is at the payment or presenter window. The digital photo would be matched to the order record created by the POS system. The photo and order record could be presented in a variety of fashions, including a print out on the receipt with the itemized order and number. Alternatively, a touch screen with the patron's picture and order record for each of the cars currently in the drive-through, and when the order is complete, the presenter would tap the photo on the touch screen indicating the order has been filled and the photo record would be removed from the system.

Specific benefits to this system include easy installation and implementation with existing QSR drive-through installations; less expensive than the current mobile terminal solutions; minimal ongoing support required; limited risk of hardware loss or damage; increased employee safety; fully supported in multi-language settings; and continues to provide the customer an opportunity to review the menu.

### BRIEF DESCRIPTION OF THE DRAWINGS

The objectives and features of the invention will become more readily apparent from the following detailed description taken in conjunction with the accompanying drawings in which:

FIG. 1 is perspective view of QSR restaurant having a drive-through ordering system in accordance to the invention;

FIG. 2 is a representative depiction of a computer touch screen displaying photo order records;

FIG. 2A is a schematic representation of a printed photo order record;

FIG. 3 is a flow chart of the operation of the drive-through ordering system;

FIG. 4 is a schematic diagram of the drive-through ordering system; and

FIG. 5 is a flow chart of a timing routine of the drive-through ordering system.

### DETAILED DESCRIPTION OF THE PREFERRED EMBODIMENT

With reference to the drawings wherein like numerals represent like parts throughout the several figures, a QSR drive-through ordering system in accordance with the present invention is generally designated by the numeral 8.

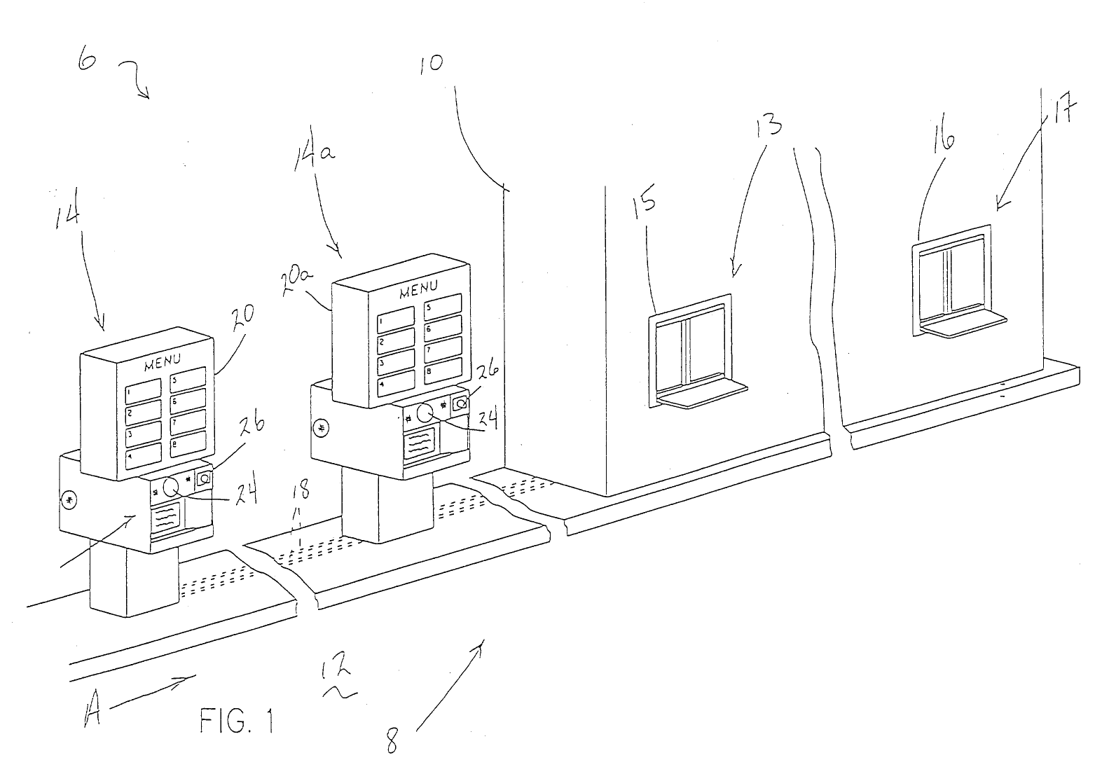

FIG. 1 illustrates a QSR fast food restaurant 6 having a drive-through ordering system 8. The illustration and employment of the invention for a fast food drive-through restaurant 6 is merely by way of example and it should be understood that as hereinafter described the invention is equally useful in other business establishments such as banks, pharmacies, or other retain stores having a drive-through or walk-up service. Even more generally, the invention is useful in any business establishment having multiple locations for order placement arid locations for order preparation and closing activities which are physically separated from the locations for order placement

The QSR establishment 6 includes a main building 10 and a drive-through system 8 having a drive-through path or lane 12 whereby customers or patrons may drive their car along lane 12 and through the premises. It should be understood that while a drive-through ordering system 8 is described, the communication system could be used for “walk-up” customers also. The main building 10 typically houses kitchen facilities and personnel. As seen in FIG. 1, drive-through lane 12 is located adjacent to building 10 whereby a motorist patron (not shown) operates his vehicle along the drive-through lane 12. At a location along the building 10, typically a payment station 13 including a payment window 15 and a presenter station 17 including a presenter window 16 is provided where the patron tenders payment for a food order and various items purchased by the customer are ultimately delivered directly to the customer, respectively, while he remains in his vehicle. To facilitate the payment and presentation (or food transfer) functions, one or more employees or attendants are typically positioned at the respective stations 13, 17 and inside building 10. The windows 15, 16 may also extend outwardly from building 10 to enable convenient transfer to and from the customer. Alternatively, the station 13, 17 and associated windows 15, 16 may be combined according to this invention.

For the motorist/patron to utilize the drive-through system, he typically enters the QSR premises onto the drive-through lane 12 in the direction shown by arrow A of FIG. 1. At a location remote from building 10, and located adjacent lane 12, multiple remote order stations 14, 14a are provided together with associated menu boards 20, 20a which each provide a list of the various food items offered by the restaurant 6 with their corresponding price. The customer stops the vehicle in the drive-through lane 12 adjacent to one of the remote order stations 14, 14a, views the menu board 20, 20a and makes selections therefrom. After the patron has decided upon which items he wishes to purchase, he then communicates his food order by utilizing the two-way audio communication system 22 including audio speakers/microphone 24, 24a at the remote station 14, 14a. After making the food selection and communicating the selection to the attendant located in building 10, the patron then proceeds along drive-through lane 12 to the payment station 13 to pay for the food order and then to the presenter station 17 where the various food items previously selected by the patron and paid for are provided to the patron while he remains in his vehicle. After receiving the food items, the patron then proceeds along drive-through lane 12 and exits the restaurant premises.

Turning now to a more detailed description of the communication system 22, generally the system is a two-way audio communication system by which a drive-through patron may communicate audibly from the remote station 14, 14a to an attendant located within building 10. In particular, the communication system 22 includes a two-way audio communication link 18 connected between the payment station 13 and the order stations 14, 14a. Communication link 18 may comprise any appropriate signal carrying means, such as the communications cables shown in FIG. 1, or communication apparatus, for example radio transceivers. The system 22 may also include a video capability. Alternatively, the communication link 18′ may provide two-way audio communication between the remote order stations 14, 14′ and a central order receiving station 19 which is separate from the payment and presenter stations 13, 17. This arrangement is useful where separating the order-taking function from the payment and presentation functions provides for a shorter processing time for serving the drive through customers.

According to one presently preferred embodiment of this invention, each of the ordering stations 14, 14a includes a preferably digital camera 26 mounted therein for taking a preferably digital photograph of the patron and/or the patron's vehicle positioned adjacent to the station 14, 14a. Preferably, the camera 26 is positioned at approximately the same angle and distance from the patron/vehicle that the drive-through attendant would view when the patron vehicle is at the payment window 15 or presenter window 16.

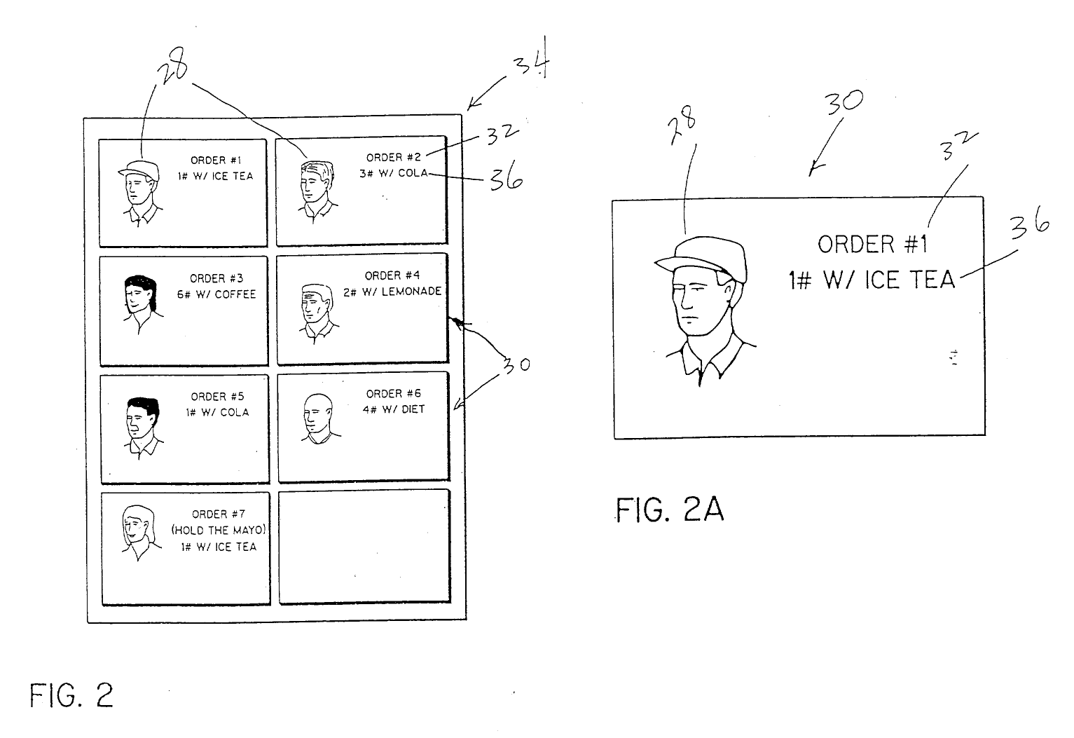

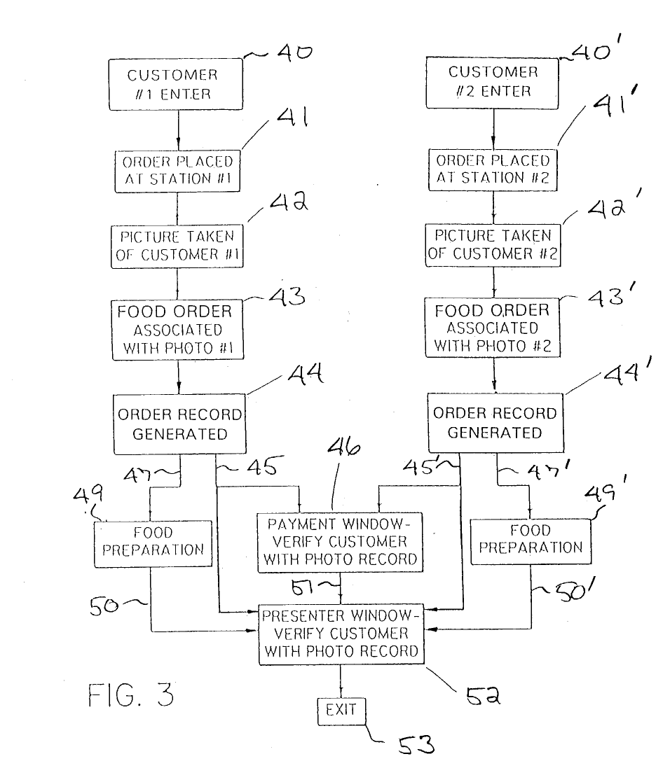

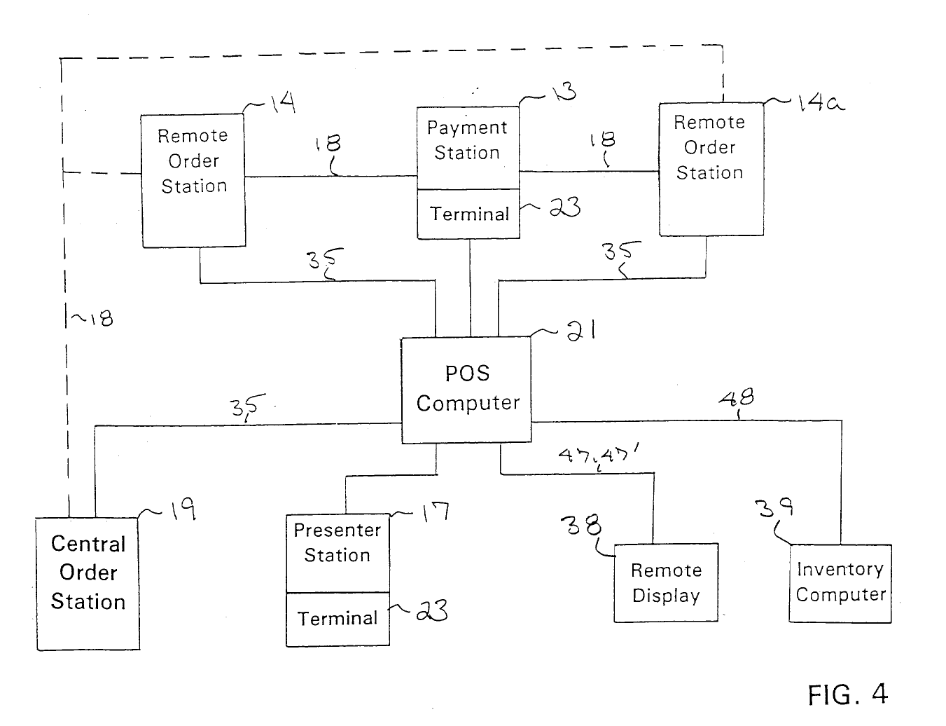

A photograph 28 of the patron/vehicle generated by the camera 26 is transmitted via cables 18 to a POS central computer 21 (FIG. 4) coupled to the POS terminals 23 at each of the stations 13, 17. The POS computer 21 generates an order record 30 for each patron which typically includes a listing 36 of the items ordered (otherwise known as a food order or more generally as an invoice), the associated price, tax and an order number 32. According to this invention, the order record 30 also includes a pictorial representation of the photo 28 of the patron/vehicle generated by the camera 26. As explained in greater detail below, all or portions of the order record 30 may be displayed on a standard display or printed by a printer at the POS terminals 23 (FIG. 2A). Alternatively, the POS terminals 23 may include a touch screen display 34 (FIG. 2) which graphically displays each of the photo order records 30 for pending food item orders for patrons in the drive-through ordering system 8.

A significant advantage of the photo order record 30 according to this invention is the ability to utilize multiple remote ordering stations 14, 14a to expedite patron ordering of food items and minimize processing time while still avoiding problems associated with order sequencing. While two remote order stations 14, 14a are shown and described herein, it should be readily appreciated that additional remote order stations could be provided within the scope of this invention.

The photo order record 30 and associated system and method for operating a drive-through ordering system 8 is as follows. During heavy traffic or when more than one patron is using the drive-through ordering system 8, a first patron pulls up 40 to remote order station 14a to place an order 41 and subsequently a second patron pulls up 40′ to remote order station 14 to place an order 41′. The orders may also be taken simultaneously. Before the customers proceed from the remote order stations 14, 14a to the payment station 13, their pictures are taken 42, 42′ by the digital camera 26 installed therein and transmitted to the POS computer 21 over a communications link 35 (FIG. 4). The orders are processed by the POS computer 21, where the food order 36 is associated 43, 43′ with the photograph 28 of customer who placed the order and generates 44, 44′ an order record 30.

The complete order record 30 may be transmitted 45, 45′ to the payment and presentation stations 13, 17, as described above. Alternatively, only the order number and pictorial representation of the photograph 28 may be transmitted to the payment station 13. When either the first or second customer arrives at the payment station 13, the attendant utilizes the pictorial representation of the photograph 28 included in the order record 30 to verify 46 that the customer at the station 13 is associated with the order record 30.

The food order 36 of each order record 30 is transmitted 47, 47′ directly from the POS computer 21 to a remote display 38 in the food preparation area. The food order 36 of each order record 30 may also be transmitted 48 to an inventory computer 39 (FIG. 4). As is customary, the food items listed in the food order 36 are prepared/collected 49, 49′ in the food preparation area and delivered to the presentation station 17.

On completion of the payment function, the payment station 13 signals 51 the POS computer 21 that payment has been received and the customer proceeds to the presenter station 17. When the customer arrives at the presenter station 17, the attendant utilizes the pictorial representation of the photograph 28 included in the order record 30 to determine 52 which food order at the station 17 is associated with the particular customer, verifies that payment has been received, and presents the appropriate food order to the customer. The presenter would then tap that photo on the touch screen indicating the order has been filled and the order identification information would be removed from the display. The customer then exits 53 the drive through system 8 and the QSR establishment 6. It should be appreciated for those QSR establishments having a single station for all closing activities ( payment and presentation of the order), that steps 41 and 52 are combined.

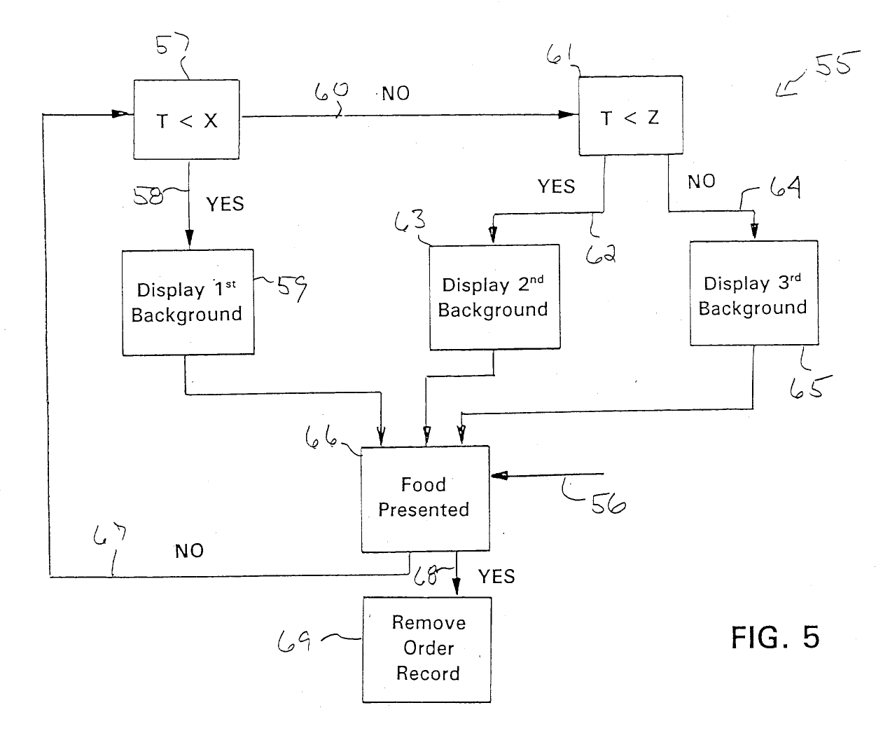

With reference to FIG. 5, the POS computer 21 may include a routine 55 which provides a visual indication of the time period between placement of the food order, as indicated by receipt of the food order 36 by the POS computer 21, and delivery of the food to the customer, as indicated by transmittal of a “delivery” signal 56 from the POS terminal 23 in the presenter station 17 that indicates that the food order has been presented to the customer. Assuming that the owner/operator of the QSR restaurant has established a delivery period “Z” which must not be exceeded, the routine 55 starts counting down the delivery time period “T” when each food order 26 is received by POS computer 21. Time period T is initially compared 57 to a target time period “X” (where X<Z). If T<X 58, the background of the photograph 28 displayed 59 at the POS terminal 23 will have a first characteristic, for example it will be green. If T is not less than X 60, time period T is then compared 61 to maximum delivery period Z. If T<Z 62, the background of the photograph 28 displayed 63 at the POS terminal 23 will have a second characteristic, for example it will be yellow. If T is not less than Z 64, the background of the photograph 28 displayed 65 at the POS terminal 23 will have a third characteristic, for example it will be red. After the food order 26 is received by the POS computer 21, the routine 55 will continuously monitor 66 for the delivery signal 56. So long as the delivery signal 56 has not been received 67, the routine 55 will continue to compare 57, 61 time period T to the target and maximum delivery periods X, Z. When the delivery signal 56 is received 68, the POS computer 21 stops transmitting 69 the information associated with the order record 30 to the POS terminal 23 and exits the routine 55 for the order record 30.

The principal benefit of the present invention is realized when the patron proceeds to the presenter station 17. Frequently, significantly large or special food orders take additional time for preparation, packaging, and delivery to the attendant at the presenter station. Such orders for example may include multiple meals and associated condiments and take significantly longer to prepare and assemble than a small order such as a beverage. However, the attendant at the presenter station 17 formerly had no way of identifying the particular order that has been prepared or is in process and associating that order with the patron located at the presenter station 17. With the present invention, simple reference to the photo order record 30 quickly, easily and efficiently identifies the patron and the order to avoid confusion by matching the appropriate order with the associated patron.

For example, if the first patron to arrive at the presenter window 16 ordered a large quantity of food and that order is not ready, a subsequent patron who has not arrived at the presenter window 16 may have ordered only a beverage. The beverage order is more easily and quickly prepared and ready for presentation at the presenter station 17 and by simple reference to the photo order record 30, the attendant at the presenter station 17 can easily identify that the particular patron currently present at the presenter window 16 does not receive the beverage order currently available. This avoids confusion associated with order sequencing while utilizing multiple remote order stations 14, 14a to alleviate the bottleneck at the remote stations 14, 14a and expedite service at a QSR establishment.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. An ordering system for a business establishment having multiple locations for order placement and locations for order preparation and closing activities which are physically separated from the locations for order placement, the system comprising:
a plurality of ordering stations, a one of the ordering stations being located at each of the locations for order placement, each ordering station including a camera positioned to take a photograph of a patron placing an order and a menu board; and
a POS system including
at least one terminal located at the location for closing activities, each of the terminals having a display and
a POS computer in communication with the at least one terminal and each ordering station, the POS computer recording an invoice of items ordered by the patron, associating the invoice with the photograph of the patron placing the order, and generating an order record for each order received from the ordering stations, each order record including an order number, the invoice, and the photograph of the patron placing the order, the POS computer transmitting identification information including the photograph and at least one of the order number or the invoice to the at least one terminal.

2. The ordering system of claim 1 the terminal includes a printer for printing the identification information transmitted by the POS computer

3. The ordering system of claim 1 wherein the terminal includes a touch screen display terminal for displaying the identification information transmitted by the POS computer.

4. The ordering system of claim 1 wherein the locations for closing activities include a payment station and a presentation station, the POS system including a terminal at each of the payment and presentation stations.

5. The ordering system of claim 4 further including a plurality of two-way communications links, a one of the communications links connecting each of the ordering stations to the payment station.

6. The ordering system of claim 1 further comprising a remote display in an order preparation area of the business establishment, the POS computer transmitting the order number and invoice of each order record to said remote display.

7. The ordering system of claim 1 further comprising an inventory computer, the POS computer transmitting the order number and invoice of each order record to said inventory computer.

8. The ordering system of claim 1 further comprising a central order taking station in communication with each of the ordering station and the POS computer.

9. An ordering system for a drive-through restaurant, the restaurant including a main building, a drive-through lane adapted for patrons of the restaurant to drive vehicles there along traversing a path adjacent to the main building, and a plurality of ordering stations located along the drive-through lane upstream of the main building, the main building including a food preparation area, a payment station having a payment window proximate the drive-through lane by which patrons may tender payment for food orders, and a presenter station having a presenter window proximate the drive-through lane and downstream from the payment station by which patrons may receive their food order, the system comprising:
a camera located at each of the ordering stations, the a camera being positioned to take a photograph of the patron placing an order;
an order taking station in two-way communications with each of the ordering station;
a plurality of terminals, a one of the terminals being located at each of the payment and presenter stations, each of the terminals having a display; and
a POS computer in communication with the order taking station and each of the terminals, the POS computer recording an invoice of food items ordered by the patron, associating the invoice with the photograph of the patron placing the order, and generating an order record for each order received from the ordering stations, each order record including an order number, the invoice, and the photograph of the patron placing the order, the POS computer transmitting identification information including the photograph and at least one of the order number or the invoice to each of the terminals.

10. The ordering system of claim 9 wherein each terminal includes a touch screen display terminal for displaying the identification information transmitted by the POS computer.

11. The ordering system of claim 9 wherein the payment station is also the order taking station.

12. The ordering system of claim 9 further comprising a remote display located in the food preparation area, the POS computer transmitting the order number and invoice of each order record to said remote display.

13. An ordering method for a drive through restaurant including a main building, a drive-through lane adapted for patrons of the restaurant to drive vehicles there along traversing a path adjacent to the main building, and a plurality of ordering stations located along the drive-through lane upstream of the main building, the main building including a food preparation area, a payment station having a terminal and a payment window proximate the drive-through lane by which patrons may tender payment for food orders, and a presenter station having a terminal and a presenter window proximate the drive-through lane and downstream from the payment station by which patrons may receive their food order, the method comprising the steps of:
taking a food order from a patron at one of the ordering stations from an order taking station;
taking a photograph of the patron before the patron leaves the ordering station;
generating an invoice of the food order;
associating the photograph with the invoice;
generating an order record including at least the photograph, the invoice, and an order number;
transmitting order identification information to the payment station and presenter station, the order identification information including the photograph and at least one of the order number or the invoice to each of the terminals;
using the photograph to correlate each food order with a patron arriving at the payment station or presenting station.

14. The method of claim 13 further comprising the step of transmitting the invoice to the food preparation area.

15. The method of claim 13 further comprising the step of transmitting the invoice to an inventory computer.

16. The method of claim 13 further comprising the step of providing a display of the time required to fill each order.

17. The method of claim 16 wherein providing a display of the time required to fill each order comprises the steps of:
begin timing each order record on receipt of the food order;
transmitting to the terminals a background of the photograph which is characteristic of the time interval from the beginning of timing; and
stop timing each order record on receipt of a delivery signal indicating that the food order has been presented to the customer.

18. The method of claim 17 wherein transmitting a background of the photograph which is characteristic of the time interval comprises the steps of:
comparing the time interval T to a target delivery time period X; and
transmitting a background of the photograph having a first characteristic if T<X.

19. The method of claim 18 wherein transmitting a background of the photograph which is characteristic of the time interval also comprises the steps of:
comparing the time interval T to a maximum delivery time period Z if T≧X; and
transmitting a background of the photograph having a second characteristic if T<Z.

20. The method of claim 19 wherein transmitting a background of the photograph which is characteristic of the time interval further comprises the step of transmitting a background of the photograph having a third characteristic if T≧Z.

21. The method of claim 17 wherein transmitting a background of the photograph which is characteristic of the time interval further comprises the step of stop transmitting order identification information to the payment station and presenter station on receipt of the delivery signal.
